(19) United States
(12) Patent Application Publication
(10) Pub. No.: US 2011/0026367 A1
(43) Pub. Date: Feb. 3, 2011

(54) Acoustic Transducer

(75) Inventor: Christoph Noelle, Konstanz (DE)

Correspondence Address: DeMont & Breyer, LLC, 100 Commons Way, Ste. 250, Holmdel, NJ, 07733, US

(73) Assignee: BAUMER ELECTRIC AG, CH-8500 Frauenfeld (CH)

(21) Appl. No.: 12/599,235

(22) PCT Filed: May 2, 2008
(86) PCT No.: PCT/CH2008/000203

§ 371 Date: Sep. 28, 2010

(30) Foreign Application Priority Data
May 7, 2007 (CH) 739/07

(51) Int. Cl. B06B 1/06; B05D 5/00

(52) U.S. Cl. 367/189; 427/243

(57) ABSTRACT

The acoustic transducer includes one or more membranes which cover cavities on a substrate by means of a uniformly thick polymer layer produced by vapor deposition. In the region of the cavities vapor deposition is performed on the surface of a liquid, which subsequently may be removed from the cavities via channels.

### FIELD OF THE INVENTION

The invention relates to an acoustic transducer and a method for manufacturing such a transducer.

### BACKGROUND OF THE INVENTION

For ultrasonic sensors which operate according to the pulse-echo principle, ultrasonic transducers having a piezoceramic disk and a matching layer are widely used. The matching layer has an acoustic characteristic impedance which is between that of the piezoceramic disk and that of the surrounding medium (generally air or water). Such ultrasonic transducers have a relatively narrow bandwidth. They are excited by electrical pulses or transmission bursts for transmitting wave packets. These acoustic waves are reflected on objects. When such echo signals strike the ultrasonic transducer they are evaluated by an electronic detection system. The propagation time between transmission of the ultrasonic bursts and reception of the echo signals is a measure of the particular distance from the object.

Miniaturization of ultrasonic sensors is desirable for many applications. For sensors having ultrasonic transducers which include a piezoceramic disk and a matching layer connected thereto, miniaturization is possible only to a limited extent.

For medical imaging applications in which ultrasonic waves are transmitted between a sensor head and the human body, using a gel, it is known to provide the sensor head with transducer elements configured in a one- or two-dimensional array. By actuating the transducer elements with relative phase positions which may be varied in a defined manner, propagation properties such as the direction of propagation or the focal region of the ultrasonic waves may be influenced.

It is also known to manufacture the transducer elements of such ultrasonic sensors as capacitive transducers, using micromechanical methods. DE-A1-10 2005 051604 discloses a method for manufacturing such capacitive ultrasonic transducer arrays, also referred to as capacitive micromechanic [sic; micromachined] ultrasonic transducers (CMUT). On account of the lower acoustic impedance of the thin transducer membranes, such transducers may also be operated in gaseous environments (air). When a semiconductor material such as silicon is used as substrate it is possible to provide electronic components on this substrate in the immediate vicinity of the transducer element. A number of process steps are necessary in conventional manufacturing methods for such capacitive micromachined ultrasonic transducers. In particular, in each case the formation of a solid sacrificial layer is provided, which must be etched away in one of the subsequent process steps. Whereas in other known methods the membranes are produced by depositing a hard nitride layer and/or by plasma-enhanced chemical vapor deposition (PECVD) (in these methods interfering mechanical stresses must be eliminated by thermal aftertreatment), DE-A1-10 2005 051604 provides a method for manufacturing a polymer-based capacitive ultrasonic transducer. The method essentially comprises the following steps:

(a) Providing a substrate; (b) forming a first conductor on the substrate; (c) coating the substrate with a sacrificial layer in order to cover the first conductor with the layer; (d) etching the sacrificial layer to form an island, thus allowing the island to be brought into contact with the first conductor; (e) coating the substrate with a first polymer-based material in order to cover the island with same; (f) forming a second conductor on the first polymer-based material; (g) forming a through opening on the first polymer-based material to allow the through opening to be led to the island; and (h) using the through opening to etch away and remove the island, thus forming a cavity.

The substrate may be made of silicon; the conductor, of sputtered copper or platinum; the sacrificial layers, of metal; and the polymer-based material, of a photoresist.

The openings provided in the polymer-based material from the front side are closed in a further process step by spin-coating with an additional layer of the polymer-based material.

The manufacture of capacitive ultrasonic transducers according to the method described in DE-A1-10 2005 051604 includes a number of process steps and is correspondingly complicated. Providing openings in the membrane for the wet-chemical etching of an underlying sacrificial layer and applying a second polymer layer which recloses these openings may impair the mechanical properties of the membrane and the reproducibility thereof.

A method is known from EP-A1-1672394 for manufacturing filters, lenses, and waveguides, wherein polymer membranes are produced by depositing plastic on a substrate and on the surface of a liquid present on the substrate. The substrate may include a plate, for example, which is covered by a structurable layer, for example a photoresist or a protective layer, for example the blue protective film used for silicon wafers. By use of known methods, structures such as channels or circular holes may be provided in this layer which are then filled with a liquid such as an optical oil, for example. Due to the surface tension, the materials used for the structured layer and the liquid result in a characteristic curvature of the liquid surface. The liquid is preferably selected in such a way that it is repelled by the structured layer and does not adhere thereto.

In a further step the substrate and liquid are coated with parylene in a low-pressure gas deposition process at a chamber pressure of approximately 7 Pa, wherein the substrate and liquid may be kept at ambient or room temperature. Di-para-xylene is pyrolyzed, then polymerized at 600° and deposited on the substrate and the liquid surface at room temperature. The liquid is nonreactive, and has a much lower saturation vapor pressure than the pressure in the reaction chamber. The liquid is then discharged through openings. Depending on the design of the structured layer, these openings may be provided, for example, at the end of a channel provided in the substrate, or are exposed by removing a pin from a borehole in the plate.

Furthermore, EP-A1-1672394 discloses the possibility of providing a channel produced according to the described method, using piezoelectric or capacitive actuators. These actuators include rectangular electrodes or piezoelectric regions situated along the channel on the membrane-like enclosure and/or on the substrate plate. By graduated periodic activation of these actuators it is possible to induce peristaltic contractions in the enclosure for transporting liquids in the channel.

In a further application of the proposed method, cylindrical recesses are formed in a layer, which is then filled with liquid and covered by a membrane. The liquid is left in the cavities between the membrane and the structured layer, resulting in microlenses. The temperature of the liquid may be changed by use of transparent heating resistors. The focal lengths of the microlenses may be altered as a result of the associated relatively sluggish change in volume.

### SUMMARY OF THE INVENTION

The object of the present invention is to provide a method for manufacturing an acoustic transducer having at least one membrane, and to provide such an acoustic transducer.

By use of the method according to the invention, acoustic transducers having one or more membranes may be easily and economically manufactured. The membranes are produced by deposition and/or application of a plastic and/or other materials on a surface of a liquid or gel, i.e., a liquid with high viscosity, and the adjacent surface of a substrate. Parylene is preferably used for producing the membranes. Depending on the composition, the parylene may be inert and/or mechanically stable and/or optically transparent and/or biocompatible. Means for exciting and/or detecting vibrations, deformations, or mechanical stresses of the membrane or portions thereof may be applied to the membrane, for example by vapor deposition or sputtering. Examples of such means include planar electrodes of capacitors, metal coatings which act as optical mirrors, lattices, or the like, multilayer systems such as DFB structures, for example, and piezoelectric or piezoresistive structures. If necessary, these detection and/or excitation means may be isolated and protected from the surroundings by an additional plastic or parylene layer. The substrate preferably has a plate-like design, and may include one or more layers. The top layer of the substrate is preferably structured using known methods such as anisotropic etching, laser machining, mechanical machining, or embossing processes. In this manner cavities or depressions having different dimensions, shapes, and surface characteristics may be provided. These depressions may then be filled with the liquid on whose surface the plastic deposition is to be carried out. Depending on the particular requirements, if necessary, means for exciting and/or detecting membrane vibrations and/or deformations or portions of such means may be applied to the substrate or provided thereon beforehand using coating or structuring techniques, for example. Examples of such means include planar electrodes, which together with the same type of electrodes on the associated membranes form capacitors whose capacitances may be modified as a function of the membrane deflections. In particular when the substrate includes a semiconductor wafer or layer, in the region beneath the membrane, for example, any given sensor elements and/or actuator elements for detecting vibrations or deflections of the membrane may be provided, i.e., the above-referenced electrodes or light-emitting diodes or laser diodes and photodiodes, for example, which detect light which is emitted by the light-emitting diodes and reflected at the membrane provided with reflectivity. Such sensor and/or actuator elements may be used for control and/or regulation tasks (closed loop feedback), for example. Use of a substrate having a semiconductor layer (a wafer, for example) has the additional advantage that even very low signal levels may be detected and amplified, essentially without interference, directly downstream from the particular sensor element. The electronics system for actuating and/or evaluating the actuator elements and/or sensor elements may thus be compactly situated on the substrate. In particular for more complex systems having multiple membranes configured to produce a one- or two-dimensional array, and which are to be excited and/or detected in a synchronous or coordinated manner, an actuation and/or detection electronics system is very advantageously integrated into the substrate. The deposition technique used for producing the membrane does not require high temperatures, and is compatible with the semiconductor structures used.

In alternative embodiments the substrate may include one or more layers of any other given materials, having the same or different layer thicknesses, such as glass, ceramic, metal, semiconductor, or plastics, for example. Such layers may have a polycrystalline, amorphous, organic, or inorganic design. The means on the membrane and/or the substrate for detecting and/or producing deflections or vibrations of the membrane are each connected to a control system via insulated strip conductors, and/or may be connected to such a control system via a suitable interface.

Depending on the intended use, the liquid used to produce the membrane on the substrate may be left in the cavity, or may be removed from the cavity from the back or side through one or more openings in the substrate. Multiple openings are preferably provided for each cavity, which during the manufacturing process are sealed by a film or pin at the back side of the substrate. When the cavities are emptied, gas is thus able to flow into the cavity through at least one of these openings. Alternatively or additionally, the liquid may be discharged, suctioned, or removed from the cavity in some other way through openings such as pores, for example, in the deposited or applied membrane. In particular, a porous membrane may subsequently be further coated or subjected to post-treatment, thereby closing the pores.

### BRIEF DESCRIPTION OF THE DRAWINGS

The invention is described in greater detail with reference to several figures, which show the following:

FIG. 1 shows a design of a capacitive ultrasonic transducer according to the prior art;

FIG. 2 shows a cross section of a first embodiment of an ultrasonic transducer having a double-layer substrate;

FIG. 3 shows a semiconductor substrate layer for a capacitive ultrasonic transducer, having an integrated electronics system and multiple electrodes for transducer elements situated along a line;

FIG. 4 shows a cross section of an ultrasonic transducer in a further embodiment;

FIG. 5 shows a cross section of a further transducer having a substrate with a single-layer design; and

FIG. 6 shows a cross section of a transducer for a ring-shaped rib structure for supporting the membrane and/or for increasing the sensitivity or the efficiency.

### DETAILED DESCRIPTION

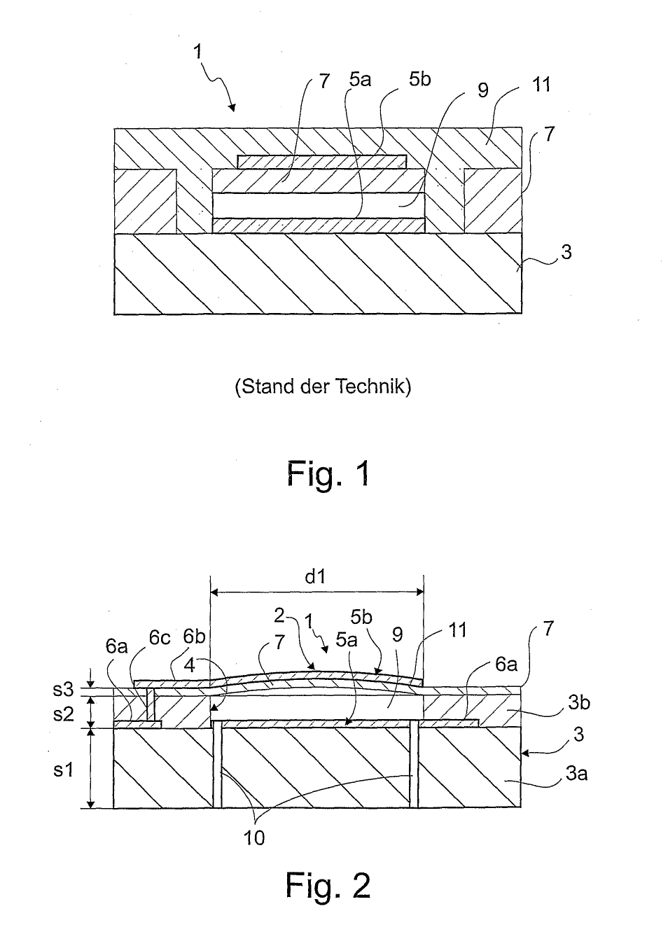

FIG. 1 shows a cross section of a capacitive micromachined ultrasonic transducer 1 as known from DE-A1-10 2005 051604. A first flat conductor region 5a is applied to a substrate 3 made of silicon. A cavity 9 which has been formed by etching away a sacrificial layer (not illustrated) previously applied to the conductor region 5a and overlapping same on the sides is provided in a first polymer layer 7 which covers the substrate 3 and conductor region 5a. Through openings through the first polymer layer 7 must be exposed in order to etch away the sacrificial layer. After applying a second conductor region 5b to the first polymer layer 7, above the cavity 9 a second polymer layer 11 is applied by means of spin-coating which recloses the through openings but leaves the cavity 9 as such. The second polymer layer 11 must be prevented from penetrating into the cavity 9 via the through openings.

FIG. 2 shows a cross section of a first embodiment of a capacitive ultrasonic transducer 1 which may be manufactured according to the invention. A substrate 3 comprises a composite composed of a flat first substrate layer 3a, i.e., a plate which may be made of an electrically insulating plastic, electrically conductive metal, or semiconductor, for example, and which has a thickness s1 of approximately 1 mm, for example, and a flat second substrate layer 3b, i.e., a plate which may be made of an oleophobic plastic such as polyethylene, PVC, or Teflon and which has a thickness s2 of approximately 0.1 mm, for example. One or more depressions or recesses 4 produced using known structuring methods such as anisotropic etching, for example, are provided in the second substrate layer 3b. These depressions or recesses may have a circular cross section, for example, with a diameter d1 of 2 mm, for example. Alternatively, the cross section of the recesses 4 could have another shape, for example elliptical or polygonal, in particular square, rectangular, or hexagonal. Depending on the design and field of application of the ultrasonic transducer 1 or the acoustic transducer in general, the layer thicknesses s1 and s2 of substrate layers 3a, 3b and the dimensions of the recesses 4 may be specified within a wide range. Thus, the first substrate layer 3a may be designed, for example, as a thin, flexible plastic film or as a solid metal, glass, or ceramic body. Accordingly, layer thicknesses s1 in the range of preferably approximately 0.1 mm to approximately 10 mm or greater may be provided. Capacitive ultrasonic transducers 1 having one or more membranes 2 which may be excited to vibrate preferably have a small thickness s2 of the second substrate layer 3b or of the depth of the recesses 4 or the structures in the second substrate layer 3b. In contrast, for transducers having optical or piezoresistive deflection or vibration detection the thickness s2 of the second substrate layer s2 [sic; 3b] may be much greater. Accordingly, layer thicknesses s2 in the range of approximately 0.05 mm to approximately 5 mm or greater may be provided. For high-frequency ultrasonic transducers 1 having a few (three, for example) or many (16 or more, for example) transducer elements which may be actuated and/or evaluated in a coordinated manner, the membrane surfaces of the individual transducer elements may be very small; on the other hand, acoustic transducers which are designed to generate acoustic signals in the audible range at relatively high sound levels preferably include a single transducer element having a relatively large membrane surface area. Accordingly, the membrane surfaces which cover the recesses 4 may range from approximately 0.001 mm² to approximately 1000 mm² or greater.

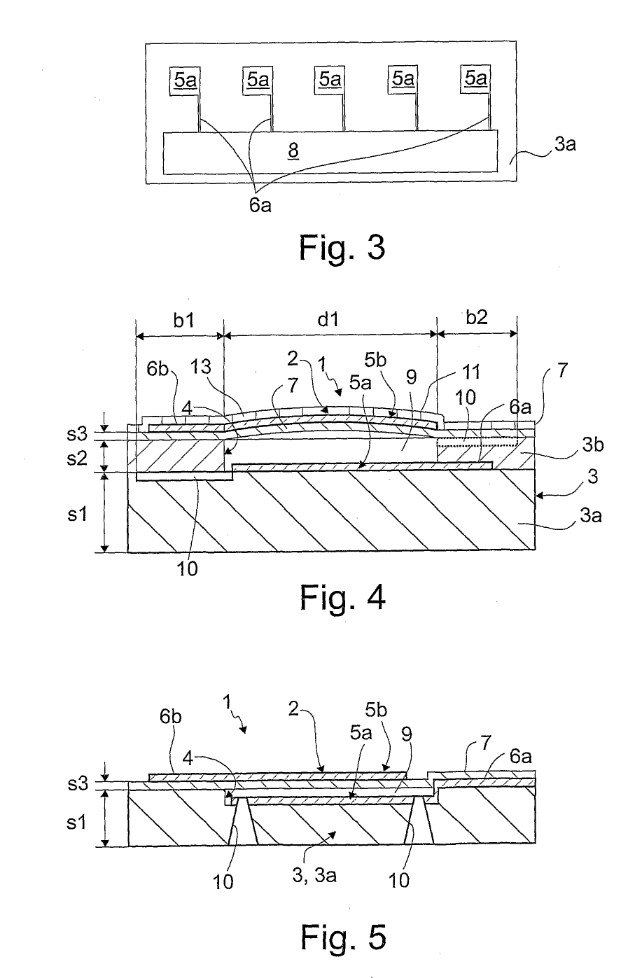

The material of the second substrate layer 3b is preferably completely removed in the region of the recesses 4, so that at that location the top side of the first substrate layer 3b or a metal coating (hereinafter also referred to as first conductor region 5a) applied to the first substrate layer 3a at least in the region of the recesses 4 is exposed. Alternatively, the first conductor region 5a could also be provided on the surface of the second substrate layer 3b facing the first substrate layer 3a, or inside the second substrate layer 3b. For insulators or semiconductors, for example, the first conductor region 5a may be produced by vapor deposition of a thin metal layer of 0.05 mm, for example, on the first substrate layer 3a, whereby the regions not to be metal-coated are masked in a customary manner using a photoresist layer. For electrically conductive first substrate layers 3a these may be used directly as first conductor regions 5a. Alternatively, electrically conductive first substrate layers 3a may be covered with a thin insulation layer, on which the first conductor region 5a is then applied. The first conductor region 5a includes, in addition to the planar electrodes in the region of recesses 4, electrical connecting lines 6a for a connection interface (connecting plugs or cables, for example) and/or for an electronic control system 8 (FIG. 3) for exciting and/or evaluating membrane vibrations or deformations. The control system 8 or portions thereof may be provided directly on the substrate 3, or alternatively, outside the transducer.

FIG. 3 schematically shows a first substrate layer 3a, made of silicon, for an ultrasonic transducer 1 comprising five transducer elements, the electrodes or first conductor regions 5a being connected via connecting lines 6a to the control system 8 which is integrated into the substrate layer 3a.

As illustrated in FIG. 2, the second substrate layer 3b and the recess 4 are covered by a homogeneous polymer layer 11, preferably a parylene layer, in such a way that each of the recesses 4 is bridged or covered by a membrane 2 delimiting a cavity 9.

A second conductor region 5b having planar electrodes in the region of membranes 2 and having connecting lines 6b is provided on the second substrate layer 3b in a manner analogous to the first substrate layer 3a. If necessary, these connecting lines may be connected via feedthroughs 6c, for example, to portions of the first conductor region 5a and/or to a possible control system 8 or a connection interface.

In one alternative design of the transducer, the second substrate layer 3b and the second conductor region 5b may be covered by a further polymer layer 11, preferably a further parylene layer, which has an electrically insulating and protective effect against mechanical and/or chemical environmental influences. Such a system is illustrated in FIG. 4.

On or in at least one of the substrate layers 3a, 3b are provided one or more channels 10 which open into the cavity 9 and allow a connection of the cavity 9 to the surroundings.

In the design of the transducer according to FIG. 2, the channels 10 penetrate the first substrate layer 3a and the electrodes on this first substrate layer 3a. The channels 10 may be provided in the first substrate layer 3a, for example by mechanical, micromechanical, or chemical machining, before or after the first conductor region 5a is applied. The channels 10 may be produced before or after the two substrate layers 3a, 3b are connected. The channels 10 may be closed in a sealing manner, for example by applying a self-adhesive plastic film (not illustrated) to the underside of the first substrate layer 3a. The channels 10 are preferably provided in the peripheral region of the cavities 9 or the electrodes placed at that location. The vibration amplitudes of the membrane 2 covering the particular recess 4, and thus interfering influences for capacitive excitation/evaluation of membrane vibrations, are minimal at that location.

For producing the membranes 2, the recesses 4 are filled with a liquid. As a rule, the externally bounded channels 10 are also filled with the liquid. The volume of liquid which may be accommodated by the channels 10 is generally small compared to the volume of liquid which may be accommodated by the recesses 4. At least the channel widths are small in comparison to the corresponding dimensions of the recesses 4. The polymer deposition is then carried out analogously to the process described in EP-A1-1672394. The membranes 2 which cover the recesses 4 or cavities 9 are thus formed. In a further step the pins or the film which seals off the channels 10 are removed, and the liquid is drained from the cavity 9. This process may be assisted, for example, by motions of the substrate 3 (in particular by centrifugation), by suction, evaporation, adsorption, or chemical reactions, as well as by the repelling effect of one or both substrate layers 3a, 3b on the liquid.

In alternative embodiments of the transducer, channels 10 may also be provided, for example, in the form of grooves or trenches in the surface of the first substrate layer 3a facing the cavity 9 and/or in one of the surfaces of the second substrate layer 3b, as illustrated in FIG. 4. Such channels 10 provided at the surface of one of the substrate layers 3a, 3b laterally project beyond the cavity 9 or the region provided for the cavity 9 by a small length b1 or b2, but without extending to the edge of the respective substrate layer 3a, 3b. After application of the polymer layer 11 and optionally further process steps, openings (not illustrated) for removing the liquid from the cavities 9 may be provided [in] the channels 10, for example using separating cuts, which are necessary for separating multiple ultrasonic transducers 1 situated on a common substrate 3, or by localized mechanical, thermal, or chemical removal of the polymer layers 7 and 11 and optionally further layers in the end regions of the channels. When such transducers are installed in a housing, these openings may optionally be kept open, with sealing or protection from the surroundings. The channels 10 may also be connected to pressure chambers or other devices for controlling or regulating the pressure in the cavity 9. The type of connections of the cavities 9 to the outside (closed, connected to a pressure chamber, or open) may, for example, influence characteristics such as damping, angle of reflection, or bandwidth, i.e., the usable frequency spectrum of an acoustic transducer.

The possibility for simultaneously providing a plurality of transducers on a substrate 3 (of course, this also applies to transducers having multiple transducer elements or membranes 2), and subsequently separating these transducers by separation processes, allows such transducers to be economically manufactured.

Instead of a double-layer substrate 3, acoustic transducers may also be produced with multiple substrate layers 3a, 3b or with only one substrate layer 3a. One possible embodiment is illustrated in FIG. 5. The surface of the substrate layer 3a is first structured with recesses 4 or depressions. The substrate layer 3a is metal-coated with a first conductor region 5a, a planar electrode being provided at the base of the recess 4 and being connected to an interface and/or optionally to an electronics system 8 via connecting lines 6a which project beyond the edges of the recess 4. The side faces of the recess 4 may be angled in a conical or pyramidal manner (not illustrated), thus ensuring a satisfactory electrical connection between the electrode in the depression and the connecting lines 6a. The depressions are filled with a liquid, analogously to the described method for double-layer substrates 3, coated with a polymer layer 7, and provided with a second conductor region 5b. The materials for the substrate 3 and the liquid are preferably selected in such a way that they, and thus the membrane 2 formed thereon, have little or no curvature at the liquid surface adjoining the side edges of the substrate. In a manner analogous to transducers having double-layer substrates 3, the liquid may be removed from the cavity 9 via channels 10 or, for ultrasonic transducer arrays for medical diagnostics or applications in liquids, for example, may be left in the cavity 9. Of course, a second polymer layer 11 may be applied in this case as well.

In further alternative embodiments the recesses 4 or depressions may include pillars, bars, or other structures for supporting the membrane 2 and/or for localized reduction of the distance between the membrane 2 and the substrate 3, i.e., island-like or contiguous regions which are in contact with the membrane 2 from the underside, or which are only a small distance from the membrane 2 and are not fixedly connected to the membrane 2. Such structures may include metal coatings which are connected to the first conductor region 5a or are a part of same.

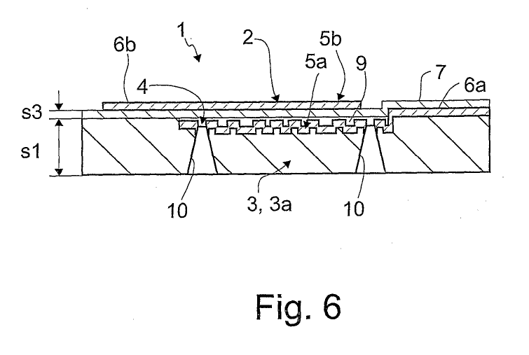

FIG. 6 shows an example of such a transducer, having structures in the form of concentric rings. These structures are covered with liquid during deposition of the polymer layer 7, so that no adhesive bond is produced between the polymer layer 7 and the rings projecting at the substrate 3. The capacitance through the two conductor regions 5a and 5b and the dielectric situated therebetween which includes the polymer layer 7 is relatively high due to the small distance of the membrane 2 from the structures.

The conductor regions 5a, 5b may be charged by application of electrical voltages. Depending on the relative polarity of the charges on the two oppositely situated electrodes, the membrane 2 curves outwardly or inwardly and is thus mechanically stressed. Parameters such as bandwidth, resonance frequency, or directional characteristic of the acoustic transducer may thus be influenced. The acoustic transducer may be used as a sonic generator for producing sound waves or ultrasonic waves by actuation with an alternating voltage signal. When the capacitance of the transducer is associated with an amplifying evaluation electronics system (which is generally a component of the electronic control system 8), the transducer may be used as a microphone, wherein sound waves striking the transducer result in corresponding vibrations of the membrane 2, which may then be detected as a change in capacitance.

Alternatively, other physical principles may be used for the excitation and/or detection of vibrations or static pressures. Thus, for example, for this purpose a piezoelectric layer, for example PVDF, may be applied to the membrane. In a further variant, piezoresistive structures are provided, preferably in the transition region between the recess 4 and the substrate 3 on the membrane 2 which supports the membrane 2, which may be used to detect membrane vibrations or deflections as resistance or a change in resistance. In a further embodiment, a light-emitting diode or laser diode, and a photodiode or a CCD line or other corresponding optical elements are provided on the substrate 3, below the metal-coated and thus reflective membrane 2. The light emitted by the light source is reflected differently at the reflective membrane 2, depending on its deflection or vibration characteristic. This may be detected and evaluated using the optical detectors. In particular it is possible to use various physical principles for excitation of membrane vibrations and evaluation of such vibrations. This decoupling allows distinct improvements, in particular for ultrasonic sensors, in which signals and echoes must be detected in very short time intervals.

Further possible uses of the acoustic transducers according to the invention include, for example, microphone-speaker combinations, mobile telephones, earphones with integrated microphone, and hearing aids.

Furthermore, by use of the method according to the invention it is possible to produce not only acoustic transducers, but also a number of other sensors which operate according to various physical principles and make use of the advantages of a mechanically stable, chemically resistant membrane 2.

The features of the invention described for various exemplary embodiments may be combined with one another in any given manner.

### LIST OF REFERENCE NUMERALS

1 Ultrasonic transducer
2 Membrane
3 Substrate
3a First substrate layer
3b Second substrate layer
4 Recesses
5a First conductor region
5b Second conductor region
6a Connecting lines
6b Connecting lines
6c Feedthroughs
7 Polymer layer
8 Control system
9 Cavity
10 Channels
11 Polymer layer

The following claims are presented for examination:

1. Method for manufacturing an acoustic transducer having a membrane, the method comprising:
covering a region of the surface of a substrate with a liquid;
depositing and/or applying and/or integrating a plastic or other material on i) the surface of the liquid that covers the region and ii) the surface of the substrate adjacent to the liquid; and
providing on the membrane means for excitation and/or sensor detection of vibrations or deformations of the membrane.

2. Method according to claim 1, wherein the liquid is removed from the transducer through one or more channels or openings in the substrate and/or the membrane.

3. Acoustic transducer having a membrane, the membrane including a uniformly thick layer of a polymer or other material which adheres to a substrate and covers a cavity in the substrate.

4. Acoustic transducer according to claim 3, wherein the polymer layer is provided by vapor deposition of a plastic on the substrate.

5. Acoustic transducer according to claim 3, wherein the polymer layer is composed of parylene.

6. Acoustic transducer according to claim 3, wherein in the region of the cavity the substrate has projecting structures situated at a small distance from the membrane.

7. Acoustic transducer according to claim 3, wherein a device or portions of a device for exciting and/or detecting deformations and/or vibrations of the membrane is provided on the membrane.

8. Acoustic transducer according to claim 7, wherein the device or portions of the device for exciting and/or detecting deformations and/or vibrations of the membrane includes a planar capacitor electrode and/or a piezoelectric or piezoresistive material and/or an optical element.

9. Acoustic transducer according to claim 3, wherein a device or portions of a device for exciting and/or detecting deformations and/or vibrations of the membrane is provided on the substrate, below the membrane.

10. Acoustic transducer according to claim 9, wherein the device or portions of the device for exciting and/or detecting deformations and/or vibrations of the membrane includes a capacitor electrode and/or a piezoelectric or piezoresistive material and/or an optical element.

11. Acoustic transducer according to claim 3, wherein the substrate includes a semiconductor substrate layer, and a control system for actuating and/or evaluating vibrations and/or deflections of the membrane is provided, at least in part, in or on the substrate layer.
